(19) United States
(12) Patent Application Publication
(10) Pub. No.: US 2005/0106359 A1
(43) Pub. Date: May 19, 2005

(54) Method of processing substrate

(75) Inventors: Wei Zou, Minnetonka, MN (US); John W. Janzen, Andover, MN (US)

Correspondence Address: Matthew Luxton;Honeywell International Inc., 101 Columbia Rd., Law Dept. AB2, Morristown, NJ, 07962, US

(73) Assignee: Honeywell International Inc.

(21) Appl. No.: 10/712,591

(22) Filed: Nov. 13, 2003

(51) Int. Cl. B32B 3/00

(52) U.S. Cl. 428/156

(57) ABSTRACT

The invention relates to methods of processing microelectronic device substrates, including methods of removing microscratches from such substrates, the methods involving smoothing or polishing the substrate surface in the presence of water, without the application of abrasive particles, and optionally without the use of chemical agents, as well as products prepared from the methods.

### FIELD OF THE INVENTION

The invention relates to methods of processing microelectronic device substrates, including methods of removing microscratches from such substrates, the methods involving polishing the substrate surface in the presence of water, without the use of abrasive particles and optionally and preferably without the use of chemical agents. Also included in the invention are products prepared from the methods.

### BACKGROUND

Microelectronic devices are prepared according to step-wise processes, starting with a substrate as the base of a microelectronic device. The substrate is typically processed for flatness (e.g., planarized), and layers of materials and patterns of materials are then deposited or coated onto the planarized surface.

Examples of substrates used as a base to prepare microelectronic devices include semiconducting substrates such as silicon wafers (e.g., polysilicon, optionally doped, or comprising a silicon oxide layer), non-conducting ceramic substrates such as aluminum nitride and aluminum oxide-titanium carbide, as well as others.

A series of various steps is normally used to process a substrate into a useful and functioning microelectronic device. A planarization step such as mechanical planarization or chemical mechanical planarization (CMP) can be used as an initial step to flatten a base substrate prior to deposition of a first layer of a microelectronic device. A planarizing step can also be used as an intermediate step, following the placement of one or more layers of a microelectronic device upon a substrate, to regenerate a very smooth and flat surface on layers of materials deposited onto the base substrate.

CMP generally involves an automated process of contacting a polishing pad to a substrate, with pressure and motion between the two, in the presence of a liquid, abrasive particles, chemical agents, or a combination of these, to wear down and flatten surface features of the substrate. The liquid or the polishing pad may include a chemical component that selectively breaks down surface features of the substrate by chemical action. The optional use of small abrasive particles in the liquid or polishing pad can also effect abrasion of the substrate. Planarization is effected, but CMP can also produce or leave behind physical imperfections or defects such as very small scratches and variations in flatness in a substrate surface, which may ultimately lead to defects in microelectronic devices prepared from such a substrate.

CMP can be followed by further processing that involves placing layers or partial layers (e.g., patterns) of materials onto the planarized substrate surface to create full or partial layers or tracks that may be conductive, insulating, magnetic, or otherwise electronically functional. The placement of each layer or partial layer, and related processing, optionally including additional planarization steps, can introduce additional physical defects such as scratches, variations in flatness, or contaminants at the surface of a layer, which also can interfere with any additional processing and which can produce defects or imperfections in a resultant microelectronic device.

There is ongoing need for new methods of processing semiconductor device substrates, including base substrates and in-process semiconductor devices, to further reduce the amounts of physical defects such as surface scratches, present at a substrate surface, which can lead to defects in devices prepared from the substrate. There is also continuing need for semiconductor device substrates, intermediates, and devices, having improved properties such as reduced amounts of defects.

### SUMMARY OF THE INVENTION

Physical defects, including scratches as small as the micron scale or the nanometer scale (e.g., in depth or width), can interfere with processing of a semiconductor device substrate, causing imperfections or flaws in microelectronic devices prepared from the substrate. The present invention relates to methods of processing microelectronic device substrates to remove scratches at a surface of a microelectronic device substrate. The substrate may be, for example, an un-processed or clean base substrate such as a clean semiconductor wafer, a planarized substrate, or an in-process microelectronic device prepared by depositing one or more layers of material, e.g., patterns of electronically functional materials, onto a base substrate (e.g., a planarized substrate).

The use of abrasive particles in microelectronic device substrate processing, especially planarization, is common. For example, according to certain chemical-mechanical processing methods, abrasive particles may be included either in a fixed abrasive pad or in a liquid medium that contacts the pad and substrate during processing. The particles can be made of various organic or inorganic materials such as silica or alumina, among others. The particles can be of a size that produces abrasion of the substrate e.g., on the sub-micron scale, such as less than 0.1 micron in diameter.

In methods of processing microelectronic device substrates, scratches may be created in a substrate during processing steps such as polishing or planarization, e.g., during chemical-mechanical planarization (CMP). A process step such as CMP may leave very small “microscratches” that have dimensions on the nanometer scale, e.g., a depth on the order of 0.1 micron (100 nanometers) or less, a width on the order of 0.05 micron (50 nanometers) or less, and a length of 10 microns or less. The present invention, in one specific embodiment, relates to methods of processing a microelectronic device substrate to reduce the size of or remove microscratches, by polishing a substrate that contains microscratches using a polishing pad in the presence of a substantially aqueous liquid and without application of abrasive particles. In particularly preferred embodiments, the process can be performed also without the use or application of other organic or inorganic chemical agents such as surfactants, basic agents, acidic agents, and other etching agents, i.e., the aqueous liquid can be water with no additives.

Also according to certain embodiments of the invention, a substrate can be processed to remove microscratches from a substrate surface by the use of a polishing step in the presence of water. The polishing step can include polishing the substrate with a polishing pad and water, without application of abrasive particles either in the water or on or in the polishing pad. Also, the polishing step can preferably be performed in the presence of a substantially aqueous liquid that includes no abrasive particles and most preferably includes no added organic or inorganic materials such as acidic or basic etchants. The inventive method does not require the use of abrasive particles, and in fact preferably excludes abrasive particles, lending to process simplicity, cost-effectiveness and reduction in size or elimination of microscratches that can be a result of the presence of abrasive particles. Also, the method does not require and can preferably exclude the use of organic solvents, surfactants, etchants, etc., or other organic or inorganic additives to the substantially aqueous liquid, also lending to simplicity and cost effectiveness.

In particular embodiments of methods of the invention, a surface of a microelectronic device substrate such as a planarized silicon wafer can be polished or smoothed to remove scratches left behind from chemical-mechanical processing, by buffing the surface with a standard CMP polishing pad in the presence of water with no additives, e.g., no added organic solvent, no added basic or acidic material, no added surface active material, and no abrasive particles. The method can use relatively high rotational speeds and relatively low pressure to remove scratches produced or left behind from chemical-mechanical processing of the substrate, e.g., microscratches having a depth on the scale of nanometers (1 to 1000 nm), especially including scratches of a depth within the low end of this size range, such as a depth of less than 0.2 micron (200 nm) or less than 0.1 micron (100 nm).

Processing a substrate according to the invention can substantially remove such microscratches from a substrate surface. For example, a substrate after processing according to the invention can have on average (number of scratches on an area divided by the area) less than 1 microscratch per area of 100 square microns (e.g., a square area the size of 10 microns in length by 10 microns in length). In certain embodiments of the invention where the substrate is a semiconductor wafer, a semiconductor wafer substrate of 200 or 300 mm (or about 4 to 8 inches) can be processed according to the invention to have no detectable scratches of a depth in the nanometer size range, e.g., no detectable scratches of a depth less than 200 run, preferably no detectable scratches of a depth in the range from 10 to 200 nanometers, or in the range from 50 to 150 nanometers. The method used for detecting the scratches can be Atomic Force Microscopy (AFM), a standard technique used in the field of surface analysis.

In particular embodiments of the invention, a substrate can be a silicon wafer that is further processed to produce a microelectronic device such as a magnetoresistive memory, e.g., a giant magnetoresistive memory. In preferred methods and processed substrates of the invention, the silicon wafer can be polished to a roughness of less than 2 angstroms (0.2 nanometers) as measured by AFM. Alternatively, a microelectronic device substrate (e.g., silicon) can have less than 1 microscratch of a depth of greater than 0.2 nanometer per 100 square microns (e.g., less than 1 microscratch per 100 square microns, the microscratches having a depth in the range from 0.2 nanometer to 100 nanometer).

The invention can be practiced using any useful equipment, such as any presently available or future developed equipment that may be designed for use in, or otherwise useful in, processing a semiconductor substrate by chemical-mechanical planarization methods. In a very general sense, processing parameters according to the invention may include relatively high rotational speeds of the pad, the substrate, or both, relatively low pressures between the pad and substrate, and a relatively soft pad, compared to many CMP methods designed for planarization. Still, other conditions and equipment may also be useful.

The pad used for processing according to the invention can be any useful pad such as any presently available or later developed pad that can be effective according to methods described herein to remove microscratches from a substrate. This will generally include many of the presently or future available standard pads used for chemical mechanical processing. Preferred pads do not include chemical or abrasive agents, and may be prepared from relatively soft materials such as felt, animal hairs, and polymer-impregnated felts, polyvinyl alcohol addition polymers, or other man-made fibers, relative to all available materials for CMP pads. The aqueous liquid can be substantially aqueous (e.g., greater than 95 percent water or greater than 99 percent water), and (e.g., for simplicity) can preferably include only water with no other additives such as abrasive particles or chemical agents. Optionally, the substantially aqueous liquid may include added ingredients such as inorganic or organic additives, but preferred embodiments of the invention can specifically exclude such additives.

An aspect of the invention relates to a method of reducing the size of microscratches in a microelectronic device substrate. The method includes providing a microelectronic device substrate comprising a surface that includes microscratches, and reducing the size of microscratches by: providing pressure and relative movement between the substrate and a polishing pad, with application of aqueous liquid, and without application of abrasive particles, to provide a polished surface having an average density of microscratches having a depth up to 0.5 micron, of less than 1 such microscratch per 100 square microns.

Another aspect of the invention relates to a method of processing a microelectronic device. The method includes processing a surface of the semiconductor wafer by chemical-mechanical planarization to produce a planarized surface that contains microscratches, and polishing the planarized surface by a method including: providing pressure and relative movement between the substrate and a polishing pad, the pressure between the polishing pad and substrate in the range of 0.2 to 3 pounds per square inch, in the presence of an applied aqueous liquid, and in the absence of applied abrasive particles.

Still another aspect of the invention relates to a microelectronic device substrate that has a surface having an average density of less than 1 microscratch per 100 square microns.

### DETAILED DESCRIPTION

The method of the invention generally relates to the use of polishing steps and equipment to process microelectronic device substrates. The method can be used in particular to remove microscratches from microelectronic device substrates. According to certain embodiments of the invention, removal of microscratches can be accomplished with the use of water (e.g., with no added ingredients) and a polishing pad, as substantially the only materials. According to such a preferred embodiment of the invention, the process can be performed without the use of any abrasive particles, and preferably without the use of chemical agents in the pad or in the water. Additionally, relatively low pressure between the pad and the substrate, in combination with relatively high spin speeds, may be used.

The method generally can be accomplished by providing a substrate and a polishing pad, in the presence of water, with relative motion between the pad and the substrate and a downforce pressing the substrate into the pad. The substrate can be any microelectronic device substrate, e.g., a ceramic substrate, a semiconductor wafer such as a silicon wafer, or another type of basic or in-process microelectronic device substrate. The substrate may be, for example, a substrate such as a cleaned, uncoated semiconductor wafer (e.g., a silicon wafer) following a planarization step. The substrate may alternatively be a substrate such as a ceramic or semiconductor wafer that may have been planarized and then processed further by depositing or coating one or more full or partial (e.g., patterned) layer of material on a surface of the substrate. The layer may be an organic layer, an inorganic layer such as a conductive metal (e.g., copper, as only a single example), a magnetic (e.g., ferromagnetic) layer, another type of conductive layer or inorganic layer such as an oxide or a metal oxide, a non-conductive layer, a dielectric or insulating layer (e.g., an interlayer dielectric or “ILD”) a polymeric layer, or any other type of material useful in a microelectronic device that may be placed as a layer or in a pattern over a substrate surface, as well as any variety of combinations of these and other layers. Such a substrate may be an in-process microelectronic device that has been partially processed to include a portion of a total amount of layers in a functional microelectronic device, and that is to be further processed by providing additional layers to the substrate to produce a finished microelectronic device such as a microprocessor, a memory device such as a magnetoresistive (MR) memory or a giant magnetoresistive (GMR) memory, a read or write head, etc. More generally, a substrate may be any type of base substrate or partially processed microelectronic device substrate that may benefit from a reduction in the size or amount of microscratches at a surface (especially following a planarization step), e.g., a substrate in a stage following planarization and prior to deposition of a layer or partial layer of a microelectronic device, and optionally following planarization after deposition of one or more layers or partial layers of a microelectronic device.

The substrate, whether after a cleaning step, immediately after a planarization step, optionally also after deposition of one or more full or partial layers of material following planarization, may have microscratches present that would result in defects or imperfections in microelectronic devices prepared by further processing of the substrate. For example, a substrate following a planarization step using CMP processing may have microscratches having dimensions of a nanometer scale, e.g., a depth on the order of 1000 nanometers or less, e.g., 500 nanometers or less; widths in the same range; and lengths in a range from 1 to 10 or 20 microns. A planarized silicon surface, for example, may have an average density of greater than 1 microscratch (of less than 1000 nanometer depth) per 100 square microns, e.g., an average density of greater than 10 microscratches or more per 100 square microns.

A significant dimension of a microscratch is depth, because a depth of a microscratch may most greatly affect the degree to which the microscratch can produce a disruption or imperfection in a microelectronic device prepared from the substrate. Using AFM measurement techniques, scratches of sizes on the scale of 1 picometer (1×10⁻¹² meter, or 0.001 nanometer) can be detected. The minimum size of a detectable microscratch, therefore, can be the size of a single atom layer at a substrate surface, which can therefore depend on the size of atoms at a substrate surface. As an example, silicon atoms at a surface of a substrate have a diameter of about 1 to 2 angstroms (0.1 to 0.2 nanometers). A minimum size microscratch for such a substrate is therefore from 1 to 2 angstroms, which is detectable by AFM. A microscratch of even this small of a depth can cause a disruption or imperfection when a microelectronic device such as a giant magnetoresistive memory is placed over the microscratch.

The method of the invention involves processing a microelectronic device substrate by polishing or smoothing a substrate surface in the presence of water, with no added abrasive particles, optionally with no added chemical reagents, preferably using pressure and timing to reduce the size of or remove microscratches. The inventive process includes contacting a polishing pad with a surface of a microelectronic device substrate, with relative motion and pressure between the two, in the presence of a liquid that contains water and no abrasive particles, to remove microscratches produced or left behind from prior processing of the substrate surface, such as scratches left behind by CMP at a surface of a microelectronic device substrate. Processing of a substrate according to the invention can substantially reduce the depth, width, length, or amount (scratches per area) of such microscratches from a substrate surface, or can preferably substantially remove such scratches that are present. To be clear, some larger scratches, if present prior to the processing steps described herein, may still remain at a surface of a substrate following processing.

As a general example, a substrate surface that exhibits scratches of a depth in the nanometer size range can have those scratches substantially removed by processing according to the invention, or may at least experience removal of substantially all of the scratches of a size in a lower portion of the nanometer range—e.g., the processed substrate can have a substantially reduced density of microscratches of a depth up to 200 nanometers, or may have no detectable scratches of a range of depths, e.g., no detectable microscratches of depth in the range from 10 to 150 nanometers.

As a relatively more specific example, a semiconductor wafer substrate of 200 millimeter (mm) or 300 mm diameter, starting with microscratches having, e.g., lengths of 10 microns or less, widths on the order of 0.05 microns (50 nanometers), and depths on the order of 0.1 microns (100 nanometers) or less, with an average density of a magnitude of 101 (e.g., 10 to 100) or more scratches per 100 square microns, can be processed according to this description to have no detectable scratches in this nanometer (width and depth) size range, or may at least be processed to have no detectable scratches of a size within a portion of the lower part of that range—e.g., no detectable scratches in the range from 0.2 nanometers to 200 nanometers (depth), or no detectable scratches in the range from 10 to 150 nanometers (depth). The scratches, before and after processing as described herein, can be identified and measured according to known methods of scratch detection, such as by Atomic Force Microscopy.

According to the invention, application of the polishing pad to the substrate, with relative motion and pressure, can include any form of motion between the pad and the substrate, such as rotation of the substrate, rotation of the pad, or preferably rotation of both pad and substrate.

The speed of the substrate, pad, or both, may be any useful speed or combination of speeds, and may depend on factors such as the type of pad used, the type of substrate being processes (e.g., whether the substrate is a bare substrate material or a coated substrate or includes a coated or patterned layer of an in-process substrate), and the amount of pressure applied between the pad and the substrate. In a general sense, relative to many typical CMP methods, the polishing process of the invention typically can be performed using a relatively soft polishing pad, relatively low pressure between the pad and the substrate, and relatively high rotational speeds of the pad, the substrate, or both. Exemplary rotational speeds of a substrate rotated about its center axis or approximately thereso, may be from 50 to 200 rpm for the substrate (e.g., having a 200 or 300 mm diameter), or from 50 to 100 rpm. Exemplary rotational speeds of a polishing pad (e.g., in combination with rotation of the substrate, see above) can be in the range from 100 to 200 rpm (e.g., having a diameter of 18 to 28 inches). A relatively high rotational speed for a polishing pad may be considered to be an angular velocity of about 10 to 20 feet per second at an outer range of a pad. During polish, the substrate may also be moved in a side-to-side motion, over a distance of 0 to 100 millimeters, in cycles of 0 to 10 per minute in addition to the rotational speeds.

The amount of pressure applied between the substrate and the pad can be any useful amount and may vary depending on factors such as the relative speeds of the substrate and pad, and the type of pad and the type of substrate, but may be a relatively low pressure compared to some typical CMP methods. Exemplary such pressures may be in the range of from about 0.2 to below 4.0 pounds per square inch, preferably less than 3 or less than 2 pounds per square inch, e.g., from 0.5 to 1.7 psi, and even more preferably from 0.8 to 1.5 pounds per square inch. Varied pressures and rotations may also be applied sequentially in a series of process steps such as starting with a higher pressure and lower rotational speed and then transitioning to a lower pressure and a higher rotational speed.

The amount of time taken to process the substrate using these conditions can be any amount of time that can be useful to reduce or remove microscratches. Exemplary amounts of time for processing to remove scratches, in combination with useful or preferred rotational speeds and pressures, may be in the range of from about 30 to about 180 seconds, although longer or shorter amounts of time may also be used or useful depending on many of the factors mentioned in this description. The process can be broken into a set of sequential polishing operations, e.g., three steps, with variable forces and rotational speeds, each lasting on the order of from 10 to 120 seconds.

The pad used for processing according to the invention can be any useful pad such as any presently available or future developed pad that can be used as described herein to remove microscratches from a substrate. Examples of useful pads may include some of the pads of the type that can be used as standard polishing pads in chemical mechanical processing, e.g., conventional or “standard” pads that do not include embedded abrasive particles or embedded chemical agents (as opposed to “fixed” abrasive pads that include abrasive particles). Such pads may be of the fibrous type that include any useful type of synthetic or natural fibrous materials, e.g., synthetic or natural fibers; felt; polymeric fibrous materials (homopolymeric or copolymeric materials) including polyolefins such as polyethylenes; polyurethanes, felt, animal hairs, and polymer-impregnated felts, polyvinyl alcohol addition polymers, or other man-made fibers. The particular pad used with any particular substrate can be selected in part to work with that particular substrate to remove scratches from that type of substrate. Examples of polishing pads that may be useful according to the invention, e.g., for use in polishing a semiconductor wafer surface, include Polytex felt pads such as those presently available commercially from Rodel Inc., 451 Bellevue Rd, Newark, Del. An example of a preferred pad is POLITEX REGULAR EMBOSSED pad, from Rodel., Inc. An example of a preferred “insert” pad is DF-200, 147 hole from Rodel, Inc.

The inventive method includes the use of an aqueous liquid in contact with the polishing pad and the substrate. According to certain preferred methods of the invention, the aqueous liquid can preferably be substantially aqueous, e.g., over 95 percent by weight water, preferably over 99 or over 99.5 percent by weight water, and in particularly preferred embodiments can be entirely water, i.e., can consist of water. Aqueous liquid that is entirely water or that consists of water means that the aqueous liquid can be entirely water from a desired source, such as a filtered, deionized, or otherwise purified source of water, or combinations of these, of a purity that is suitable for industrial use. Such water will normally not technically be 100 percent pure water (100 percent pure H₂0 molecules) (i.e., will not be free of all impurities), but will normally contain some acceptable level of impurities such as minerals and ions that are not generally removed by normal purification methods such as distillation, deionization, or filtering, but which also do not prevent the water from being used industrially such as according to presently described methods or other semiconductor processing applications. For example, an aqueous liquid that consists of water can be an aqueous liquid taken directly from a source such as any type of filtered, distilled, deionized, or otherwise purified water, with no added abrasive particles and with no added chemical agents of the type that are sometimes used for chemical mechanical processing, and which can include surfactants, acidifying agents, basic agents, etchants, etc. When no chemical agents are added to the water, as can be preferred, the pH of the water can normally be the pH of the starting filtered, distilled, or deionized water, which typically is approximately neutral, e.g., from 6 to 8, or from 6.5 to 7.5.

In other embodiments of the invention, while perhaps being less preferred due to added complexity, the aqueous liquid may optionally include small amounts of materials that may improve the effectiveness of a scratch-removal process according to the invention, such as small amounts of surfactant, etchant, buffers, or acidic or basic agents. Still, as noted, these additives are not necessary to practice the invention, and preferred embodiments of the invention do not require the use of any such agents; may exclude the addition of any such material to the water; or may, if at all, use only small amounts of such additives to the water, such as less than 5 percent by weight, especially less than 1 percent or less than 0.5 percent by weight, based on the total amount of aqueous liquid, the balance of which is water.

The process can be carried out using standard polishing equipment such as commercially available chemical mechanical processing equipment. Such equipment generally includes a carrier or platen for holding one or multiple substrates to be planarized (or, according to the invention, polished or smoothed); a polishing pad for contacting the substrate or substrates with pressure; and a source of a liquid and apparatus for dispensing the liquid to substrate and pad surfaces. The substrate, pad, or both, move, generally by rotating, with applied pressure, to polish or planarize the substrate surface. Examples of equipment useful for chemical-mechanical planarization methods include apparatus useful to polish a single or multiple wafers at once, such as those available commercially from Westech Systems Inc., Phoenix Ariz. One common type of wafer polishing apparatus is the 6DS-SP made by Strasbaugh, Inc., of San Luis, Obispo, Calif. A single wafer is held by each substrate carrier of the 6DS-SP. The substrate carrier rotates about the axis of the wafer. A large circular abrasive pad is rotated while contacting the rotating wafer and substrate carrier. The rotating wafer contacts the larger rotating abrasive pad in an area away from the center of the abrasive pad.

According to one particular example of the invention, a substrate can be in the form of a planarized or otherwise in-process semiconductor substrate that has scratches at a surface of a size in the range of nanometers, e.g., lengths of 50 microns or less, widths on the order of 0.5 microns or less, and depths on the order of 0.5 microns or less, with a density of tens or more scratches per 100 square microns. According to the invention, the substrate can be processed to reduce the size of the microscratches and preferably to substantially remove all of the scratches in the nanometer size range (or a lower portion thereof), by processing as described herein, using a polishing pad and an aqueous liquid preferably consisting of water, in the absence of abrasive particles, and with a standard, preferably relatively soft, polishing pad. Examples of pads include POLITEX REGULAR EMBOSSED pad, from Rodel Inc., as a preferred pad, and DF-200, 147 hole from Rodel, Inc., as a preferred insert pad. The process can be performed using a Strasbaugh 6DS-SP apparatus fitted with a standard polishing pad as described. The substrate can be mounted in the CMP apparatus and rotated at a speed in the range from 50 to 100 rpm. The polishing pad can be rotated at a speed in the range from 70 to 90 rpm using a single pad of, e.g., 24 inch diameter. The pressure applied to the substrate by the pad can be in the range of from 0.5 to 2.0 psi. The substrate can be polished for a time in the range from 1 to 3 minutes, or for an amount of time that will reduce or substantially eliminate microscratches from the substrate surface. Optionally, more the process can be performed in steps, such as in three steps of 15 or 20 seconds, the steps being performed with the same or different parameters of table speed, spindle speed, or pressure.

Other specific embodiments of the invention can relate to the use of a polishing or smoothing step described herein in combination with other steps sometimes used in processing a microelectronic device substrate. An example is the process of first planarizing a prepared (e.g., cleaned) base substrate using a standard or useful CMP method, e.g., using a fixed abrasive pad or a conventional pad and an abrasive slurry, optionally with chemical agents such as an etchant present in a polishing liquid or an abrasive pad. This step can be used to remove bulk material from a substrate surface or to produce smoothing of relatively coarse surface.

Such a chemical mechanical polishing step can include any combination of a variety of specific techniques known in CMP processing. In general, a CMP process involves mounting a microelectronic device substrate such as a semiconductor wafer or in-process microelectronic (e.g., semiconductor) device, on a carrier or polishing head, and pressing the surface of the substrate against a rotating polishing pad. A traditional slurry-based CMP process uses a standard polishing pad in combination with a liquid slurry that includes a chemically reactive agent and abrasive particles. Recently developed “slurryless” CMP processes use fixed-abrasive pads in conjunction with polishing liquids containing chemically reactive agents but no abrasive particles. A standard polishing pad has a durable surface with no embedded abrasive particles. According to methods of the invention that involve a step of planarizing a substrate, any of these or other CMP techniques involved in general or specific CMP processing may be used to planarize a substrate. As stated, such a planarization process will normally produce scratches in the nanometer size range.

A next step may be a step for removing leftover abrasive particles, such as by a water spray rinse. In general, water is used in a pressure and volume to remove a substantial portion of abrasive particles at the surface of the planarized substrate.

A next step can be the polishing or smoothing step described above, which reduces or substantially eliminates microscratches in the substrate surface that are of a nanometer scale, especially scratches that are of a size up to 100 or 200 nanometers.

A subsequent step can be a cleaning and drying process wherein additional defects or impurities are removed and the substrate is dried.

Next, the substrate can be further processed into a microelectronic device by application of selected layers full, partial, or patterned layers, that may be electronically functional, such as conductive, insulative, or that may be otherwise useful in the processing of a microelectronic device (e.g., a photoresist, a developer solution, among others).

As one example, following polishing according to the invention, a substrate may be prepared into a magnetoresistive or giant magnetoresistive memory device by application of a series of film stacks. Such processes and devices are described, e.g., in U.S. Pat. Nos. 6,048,739 5,569,617, the disclosures of which are incorporated herein by reference. The use of the processing steps described herein for preparation of such a stacked memory device can provide useful improvements in substrate surfaces, e.g., in the form of a reduction in the size or amount microscratches at the surface of the substrate, which can interfere with subsequent processing. This reduction in the size or number of microscratches can lead to higher efficiencies in processing such memory devices on a substrate, by reducing defects caused by the microscratches.

One specific example of process parameters useful according to the invention, for polishing a semiconductor wafer substrate, using a Strasbaugh 6DS-SP system, are identified below. The process used three steps of 15 seconds, 15 seconds, and 20 seconds, at pressures of 1.5, 0.8, and 1.5 psi, respectively.

Machine Hardware and Consumables

| | |
|---|---|
| POLISH PAD | POLITEX REGULAR EMBOSSED from Rodel Inc. |
| INSERT PAD | DF-200, 147 HOLES from Rodel Inc. |
| CHEMISTRY | Deionized water only-no slurry |

Polish Parameters

| | | | |
|---|---|---|---|
| STEP | 1 | 2 | 3 |
| LEFT TIME (sec) | 15 | 15 | 20 |
| RIGHT TIME (sec) | 15 | 15 | 20 |
| POLISH FORCE (PSI) | 1.5 | 0.8 | 1.5 |
| RING FORCE (PSIG) | 0 | 0 | 0 |
| LEFT BKPRS (PSIG) | −1.0 | 0 | 0.1 |
| RIGHT BKPRS (PSIG) | −1.0 | 0 | 0.1 |
| FORCE RAMP (SEC) | 3 | 3 | 3 |
| BKPRS RAMP (SEC) | 5 | 3 | 3 |
| SPINDLE SPEED (rpm ccw) | 70.0 | 70.0 | 90.0 |
| TABLE SPEED (rpm ccw) | 50.0 | 50.0 | 70.0 |
| SLURRY 1 FLOW (mL/min) | 0 | 0 | 0 |
| SLURRY 2 FLOW (mL/min) | 0 | 0 | 0 |
| SLURRY 3 FLOW (mL/min) | 0 | 0 | 0 |
| DI WATER FLOW | ON | ON | ON |

1. A method of reducing the size of microscratches in a microelectronic device substrate, the method comprising
providing a microelectronic device substrate comprising a surface that includes microscratches,
reducing the size of microscratches by a method comprising
providing pressure and relative movement between the substrate and a polishing pad,
with application of aqueous liquid, and
without application of abrasive particles,
to provide a polished surface having an average density of microscratches having a depth up to 0.5 micron, of less than 1 such microscratch per 100 square microns.

2. The method of claim 1 wherein the polished surface has an average density of microscratches having a depth in the range from 0.001 to 0.1 micron, of less than 1 such microscratch per 100 square microns.

3. The method of claim 1 wherein the polished surface has an average density of microscratches having a depth in the range from 0.2 nanometers to 0.1 microns, of less than 1 such microscratch per 100 square microns.

4. The method of claim 1 wherein the polished surface has an average density of microscratches having a depth in the range from 0.2 nanometers to 0.5 microns, of less than 1 such microscratch per 100 square microns.

5. The method of claim 1 wherein the microscratches of the polished surface have widths in the range from 0.01 to 0.05 micron.

6. The method of claim 1 wherein the microscratches of the polished surface have
a depth up to 0.1 micron,
a width up to 0.05 micron, and
a length up to 10 microns.

7. The method of claim 1 comprising processing a surface of the substrate by chemical-mechanical planarization, followed by reducing the size of microscratches by a method comprising providing pressure and relative movement between the substrate and polishing pad, in the presence of aqueous liquid consisting of water.

8. The method of claim 1 wherein the microelectronic device substrate is a planarized semiconductor wafer.

9. The method of claim 8 wherein the semiconductor wafer is a planarized silicon wafer.

10. The method of claim 1 wherein the polishing pad comprises felt, polymer impregnated felt, polymer, animal hair, or combinations thereof.

11. The method of claim 1 wherein
the surface is polished using a rotating polishing pad and a rotating substrate, and
the pressure between the polishing pad and substrate is in the range of 0.2 to 3 pounds per square inch.

12. The method of claim 11 wherein
the polishing pad has a diameter in the range from 18 to 28 inches, and is rotated at a speed of from 100 to 200 revolutions per minute, and
the substrate has a diameter in the range from 4 to 8 inches, and is rotated at a speed of from 50 to 100 revolutions per minute.

13. The method of claim 1 wherein
the aqueous liquid consists of water, and
the processed surface includes no detectable microscratches having dimensions of a depth in the range from 1 nanometer to 0.1 microns.

14. The method of claim 13 wherein the water is selected from the group consisting of a purified water, a deionized water, a distilled water, a filtered water, and mixtures thereof.

15. The method of claim 1 wherein
the microelectronic device substrate comprises a planarized silicon wafer, and
the method comprises further processing the substrate by providing a component of a magnetoresistive memory device at a substrate surface.

16. The method of claim 15 wherein the component is a component of a giant magneto resistive device.

17. A method of processing a microelectronic device, the method comprising
processing a surface of the semiconductor wafer by chemical-mechanical planarization to produce a planarized surface that contains microscratches,
polishing the planarized surface by a method comprising
providing pressure and relative movement between the substrate and a polishing pad, the pressure between the polishing pad and substrate in the range of 0.2 to 3 pounds per square inch,
in the presence of an applied aqueous liquid, and
in the absence of applied abrasive particles.

18. The method of claim 17 wherein the substrate, having a diameter in the range from 4 to 8 inches, is rotated at a speed in the range from 50 to 100 revolutions per minute.

19. The method of claim 18 wherein
the pad, having a diameter in the range from 18 to 28 inches, is rotated at a speed in the range from 100 to 200 revolutions per minute,
for a total time of from about 1 to about 3 minutes.

20. The method of claim 19 wherein the polished surface includes on average fewer than 1 microscratch per 100 square microns, the microscratches having dimensions of
a depth no greater than 0.1 micron,
a width no greater than 0.05 micron, and
a length no greater than 10 microns.

21. The method of claim 20 wherein
the aqueous liquid consists of water, and
the force between the polishing pad and substrate is in the range of 0.2 to 2 pounds per square inch.

22. The method of claim 20 wherein
the substrate, having a diameter in the range from 4 to 8 inches, is rotated at a speed in the range from 50 to 100 revolutions per minute.
the polishing pad, having a diameter in the range from 18 to 28 inches, is rotated at a speed of from 100 to 200 revolutions per minute, and
the substrate is polished for a total time of from about 1 to about 3 minutes.

23. A microelectronic device substrate comprising a surface having an average density of less than 1 microscratch per 100 square microns.

24. The substrate of claim 23 comprising a surface having an average density of microscratches having a depth in the range from 0.2 nanometers to 0.5 microns, of less than 1 such microscratch per 100 square microns.

25. The substrate of claim 24 wherein the microscratches have a depth of no greater than 0.1 micron.

26. The substrate of claim 23 comprising a surface that includes no detectable microscratches of a depth in the range from 0.2 nanometer to 0.1 micron.

27. The substrate of claim 26 wherein the substrate is a semiconductor wafer.

28. A giant magnetoresistive memory device comprising the semiconductor wafer substrate according to claim 23.
